(19) United States
(12) Patent Application Publication
(10) Pub. No.: US 2016/0088674 A1
(43) Pub. Date: Mar. 24, 2016

(54) EFFICIENT RESUMPTION MECHANISM FOR GSM SERVICES IN DSDS DEVICES AFTER ACQUIRING BACK THE RF CHAIN

(71) Applicant: QUALCOMM Incorporated, San Diego, CA (US)

(72) Inventors: Ravi Kanth Kotreka, Hyderabad (IN); Siddhant Mehrotra, Hyderabad (IN)

(21) Appl. No.: 14/490,560

(22) Filed: Sep. 18, 2014

(51) Int. Cl. H04W 76/02; H04W 72/02

(52) U.S. Cl. CPC H04W 76/028; H04W 72/02; H04W 84/042

(57) ABSTRACT

A method for managing radio access technology services includes: reacquiring control of a radio frequency (RF) chain of a mobile communication device by a first subscription; performing a search for a base station serving a cell in which the mobile communication device is currently located; decoding only a Frequency Control Channel (FCCH) and a Synchronization Channel (SCH) transmitted by the base station; comparing a decoded Base Station Identity Code (BSIC) with a stored BSIC of a last serving cell on which a packet switched (PS) context for a data call on the first subscription was suspended or on which idle mode operations were last performed on the first subscription; and if the decoded BSIC matches the stored BSIC, resuming the data call on the first subscription on the last serving cell.

### BACKGROUND

In a Dual-Subscriber Identity Module (SIM), Dual-Standby (DSDS) mobile communication device, one subscription is typically a voice (i.e., circuit switched (CS)) and data (i.e., packet switched (PS)) enabled subscription (CS+PS), for example, Global System for Mobile communications (GSM) CS+PS and the other subscription is typically a voice-only (CS-Only) subscription, for example, GSM CS-Only. Because the DSDS device shares a single radio frequency (RF) chain between the subscriptions, when the GSM CS+PS subscription is performing data transfer on a data call, if there is Mobile Originated/Mobile Terminated (MO/MT) activity on the GSM CS-Only subscription, the PS connection on the GSM CS+PS subscription is released abnormally from the access stratum (i.e., the functional layer in the wireless telecom protocol stacks between the communication network and mobile communication device) perspective and the PS context is suspended.

When the call on the GSM CS-Only subscription is terminated, the GSM CS+PS subscription may have lost the timing information and/or moved away from the original serving cell into a cell that the original serving cell may not be able to communicate with immediately. The loss of timing information and/or change of serving cell results in a delay in resuming the PS context on the GSM CS+PS subscription. Other situations in which the GSM CS+PS subscription may be denied access to the RF chain for extended periods include cell reselection, location area update (LAU) procedure, public land mobile network (PLMN) selection, long Short Message Service (SMS) sessions, etc.

Conventionally, the mobile communication device will try to decode Paging Channels if in idle mode or send Random Access Channel (RACH) messages when RF resource are acquired after an extended period of denial of RF resources, depending upon the state of the mobile communication device. The mobile communication device must perform multiple iterations of transmitting RACH messages to obtain the correct timing to decode the downlink (DL) channels, which may result in a power penalty. In addition, the mobile communication device may encounter Access Grant Channel (AGCH) failures or not receive access grants from the network if the RACH messages are not reaching the network. If the mobile communication device has drifted from cell coverage on which the mobile was last camped, it will introduce a significant delay (e.g., 3-5 seconds) in camping back to the cell or resuming PS service.

### SUMMARY

Apparatuses and methods for managing radio access technology services are provided.

According to various embodiments there is provided a method for managing radio access technology services. The method may include: reacquiring control of a radio frequency (RF) chain of a mobile communication device by a first subscription; performing a search for a base station serving a cell in which the mobile communication device is currently located; decoding only a Frequency Control Channel (FCCH) and a Synchronization Channel (SCH) transmitted by the base station; comparing a decoded Base Station Identity Code (BSIC) with a stored BSIC of a last serving cell on which a packet switched (PS) context for a data call on the first subscription was suspended or on which idle mode operations were last performed on the first subscription; and if the decoded BSIC matches the stored BSIC, resuming the data call on the first subscription or performing idle mode operations on the first subscription on the last serving cell.

According to various embodiments there is provided a method for managing radio access technology services. The method may include: searching on an Absolute Radio-Frequency Channel Number (ARFCN) for a last serving cell on which a packet switched (PS) context for a data call on a first subscription was suspended or on which idle mode operations were last performed on the first subscription to acquire a Frequency Control Channel (FCCH) and a Synchronization Channel (SCH); decoding only the FCCH and SCH; searching for a best available cell to camp on if the FCCH and SCH are not successfully decoded; camping on the best available cell; and continuing the data call on the first subscription or performing idle mode operations on the first subscription on the best available cell.

According to various embodiments there is provided a mobile communication device. The mobile communication device may include: an RF chain comprising a modem, a transceiver, and an antenna; and a control unit configured to determine which subscription can utilize the RF chain.

When the control unit determines a first subscription can utilize the RF chain, the control module is configured to: cause the first subscription to reacquire control of a radio frequency (RF) chain; perform a search for a base station serving a cell in which the mobile communication device is currently located; decode only a Frequency Control Channel (FCCH) and a Synchronization Channel (SCH) transmitted by the base station; compare a decoded Base Station Identity Code (BSIC) with a stored BSIC of a last serving cell on which a packet switched (PS) context for a data call on the first subscription was suspended or on which idle mode operations were last performed on the first subscription; and if the decoded BSIC matches the stored BSIC, resume the data call on the first subscription or perform idle mode operations on the first subscription on the last serving cell.

According to various embodiments there is provided a mobile communication device. The mobile communication device may include: a modem configured to code and decode radio access technology (RAT) signals; a transceiver configured to transmit and receive the RAT signals; and a control unit.

The control unit may be configured to: cause the transceiver and modem to search on an Absolute Radio-Frequency Channel Number (ARFCN) for a last serving cell on which a packet switched (PS) context for a data call on a first subscription was suspended or on which idle mode operations were last performed on the first subscription to acquire a Frequency Control Channel (FCCH) and a Synchronization Channel (SCH); decode only the FCCH and SCH; cause the transceiver and modem to search for a best available cell to camp on if the FCCH and SCH are not successfully decoded; camp on the best available cell; and continue the data call on the first subscription or performing idle mode operations on the first subscription on the best available cell.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments; and

FIG. 2 is a flowchart illustrating a method for resuming communication services according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

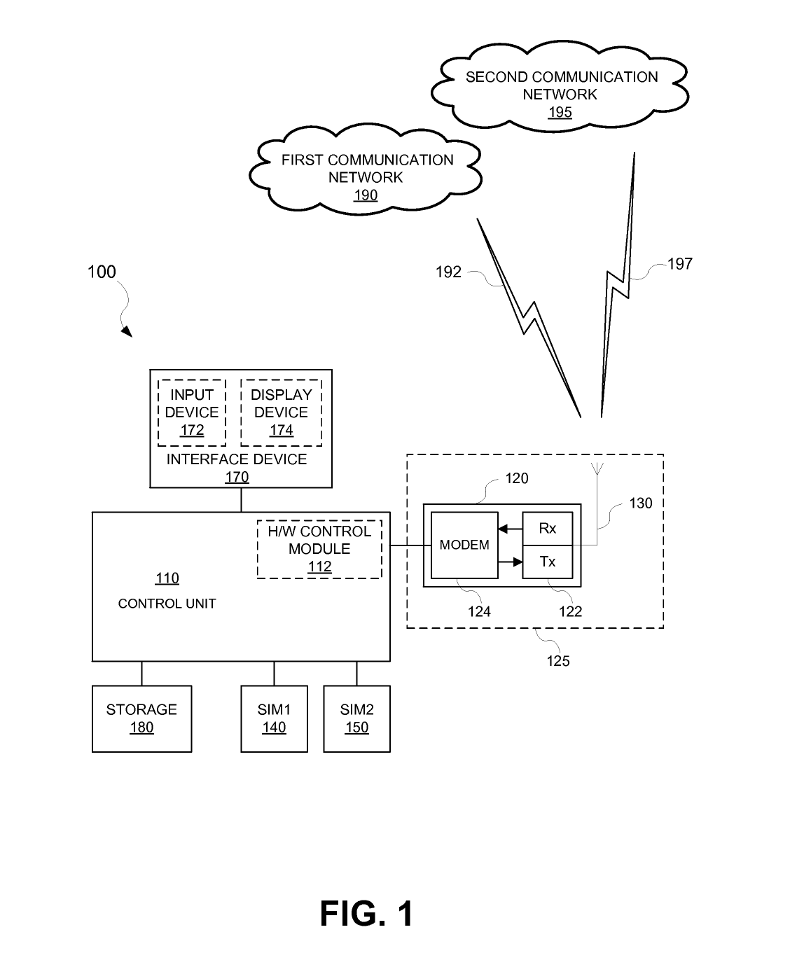

FIG. 1 is a block diagram illustrating a mobile communication device 100 according to various embodiments. The mobile communication device 100 may be, for example but not limited to, a mobile telephone, smartphone, tablet, computer, etc., capable of communications with one or more wireless networks. As illustrated in FIG. 1, the mobile communication device 100 may include a control unit 110, a communications unit 120, an antenna 130, a first SIM 140, a second SIM 150, a user interface device 170, and a storage 180.

The communications unit 120 may include, for example, but not limited to, include a transceiver 122 configured to transmit and receive radio frequency (RF) signals on the antenna 130, and a modem 124. In active mode, a communications unit (e.g. communications unit 120) receives and transmits signals. In idle mode, a communications unit receives but does not transmit signals. An RF chain 125 may be defined to include, for example, but not limited to, the transceiver 122, the modem 124, and the antenna 130.

The first SIM 140 may associate the communications unit 120 with a first subscription (Sub1) 192, for example a GSM CS+PS subscription, on a first communication network 190 and the second SIM 150 may associate the communications unit 120 with a second subscription (Sub2) 197, for example a GSM CS-Only subscription, on a second communication network 195. One of ordinary skill in the art will appreciate that other radio access technologies (RATs) may be used without departing from the scope of the inventive concept.

For convenience, throughout this disclosure Sub1 192 is associated with a CS+PS subscription and Sub2 197 is associated with a CS-Only subscription. One of ordinary skill in the art will appreciate that either or both of the first subscription 192 and the second subscription 197 may be a CS+PS subscription without departing from the scope of the inventive concept.

The first communication network 190 and the second communication network 195 may be operated by the same or different service providers. In some embodiments, The first communication network 190 and the second communication network 195 may support the same or different radio access technologies (RATs), for example, but not limited to, Wideband Code Division Multiple Access (WCDMA) and GSM. One of ordinary skill in the art will appreciate that other RATs may be used without departing from the scope of the inventive concept.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the inventive concept.

The control unit 110 may be configured to control overall operation of the mobile communication device 100 including control of the communications unit 120, the user interface device 170, and the storage 180. The control unit 110 may be a programmable device, for example, but not limited to, a microprocessor or microcontroller.

The control unit 110 may include a hardware control module 112 that may be configured to determine which subscription can utilize the RF chain. Alternatively, the hardware control module 112 may be implemented as electronic circuitry separate from the control unit 110.

The storage 180 may be configured to store application programs necessary for operation of the mobile communication device 100 that are executed by the control unit 110, as well as application data and user data.

Various embodiments provide a mechanism for resuming Sub1 192 PS services after interruption of data transfer operations and/or performing idle mode operations on Sub1 192 in a DSDS mobile communication device 100 when the RF chain 125 is reacquired by Sub1 192 after the RF chain 125 has been controlled by Sub2 197 a predetermined period of time. for example, about one or more seconds. If Sub2 197 is on voice call (that may have interrupted a data call on Sub1 192) for a predetermined period of time, Sub1 192 may not tune away to receive network pages and therefore cannot update time and frequency tracking. If the mobile communication device 100 cannot extrapolate the time and frequency tracking, the mobile communication device 100 may be unable to reacquire the previous cell even if still in range.

The mobile communication device 100 may perform a quick probe of the Absolute Radio-Frequency Channel Number (ARFCN) for the last serving cell on which Sub1 192 performed idle mode operations or on which the PS context for the data call was suspended to try to acquire and decode the FCCH and SCH to quickly correct time and frequency tracking errors. By attempting to decode only the FCCH and SCH the mobile communication device 100 may not experience additional control channel decode failures and timing corrections may be faster.

If the mobile communication device 100 cannot decode the FCCH and SCH, the mobile communication device 100 may determine that it cannot reacquire the cell the mobile communication device 100 was previously camped on and scan the Broadcast Control Channel (BCCH) Allocation List (BA List) (i.e., a list of frequencies of neighboring cells maintained by every cell) to find the best available cell (i.e., strongest signal and/or best channel quality) in the vicinity to camp on.

If the mobile communication device 100 is unable to decode the FCCH and SCH, the mobile communication device 100 may have drifted away from the cell that the mobile communication device 100 was previously camped on and cannot reacquire the cell. The mobile communication device 100 may declare downlink signaling failure and may initiate a BA List power scan (i.e., a scan of a list of frequencies of neighboring cells maintained by every cell) to find a best available cell (e.g., a cell with the strongest signal and/or best channel quality) in the vicinity to resume data transfer.

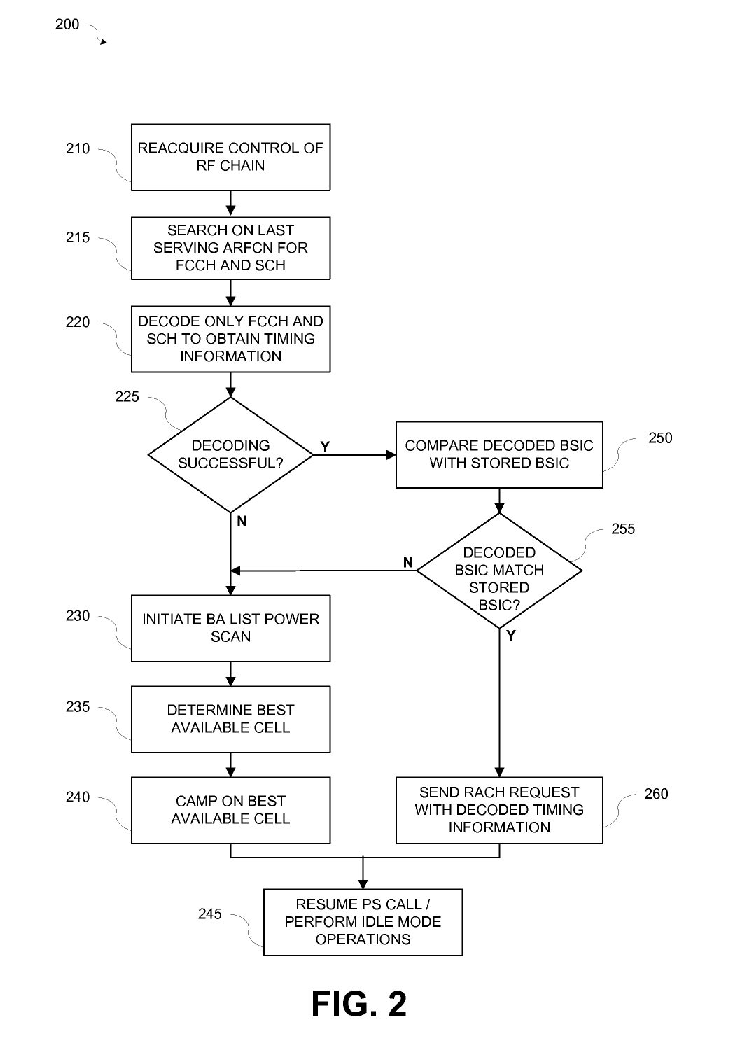

FIG. 2 is a flowchart illustrating a method 200 for resuming subscription services according to various embodiments. Referring to FIGS. 1 and 2, at some time after suspending a PS context for a data call or after performing the last idle mode operations on Sub1 192, for example due to a voice call or extended idle mode operations of Sub2 197, the hardware control module 112 (the control unit 110) may permit Sub1 192 to reacquire control of the RF chain 125 (210). If Sub1 192 has been unable to communicate with the network (e.g., the first communication network 190) using the RF chain 125 as a result of the RF chain 125 being used by Sub2 195, Sub1 192 may lose synchronization with the network.

The control unit 110 may cause the mobile communication device 100 to search on ARFCN for the last serving cell on which the PS context for the data call on Sub1 192 was suspended or on which the last Sub1 192 idle mode operations were performed to check for the FCCH and SCH (215) and to attempt to decode only the received FCCH and SCH from the cell that is currently serving the mobile communication device 100 to obtain timing information (220). If the mobile communication device 100 does not successfully decode the FCCH and SCH (225—N), the cell on which the PS context for the data call was suspended or the last Sub1 192 idle mode operations were performed may no longer be serving the mobile communication device 100.

The control unit 110 may cause the mobile communication device 100 to initiate a BA list power scan to identify frequencies of neighboring cells maintained by every cell (230). Based on the results of the scan, the control unit 110 may determine a best available cell to camp on (235). A best available cell may be determined by quality parameters, for example, but not limited to, strongest signal, best channel quality, etc. The control unit 110 may then cause the mobile communication device 100 to camp on the determined best available cell (240) and resume the suspended PS call on Sub1 192 or perform idle mode operations on Sub1 192 (245).

If the mobile communication device 100 successfully decodes the FCCH and SCH (225—Y), the control unit 110 may compare the decoded Base Station Identity Code (BSIC) to a stored BSIC of the base station last serving the mobile communication device 100 when the PS context was suspended (250).

If the decoded BSIC matches the stored BSIC (255—Y), the last serving base station may still be serving the mobile communication device 100. The control unit 110 may cause the mobile communication device 100 to send a RACH request with the decoded timing information to the last serving base station (260) and resume the suspended PS call on Sub1 192 or perform idle mode operations on Sub1 192 (245).

If the decoded BSIC does not match the stored BSIC (255—N), the control unit 110 may cause the mobile communication device 100 to initiate a BA list power scan (230). Based on the results of the scan, the control unit 110 may determine a best available cell to camp on (235). A best available cell may be determined by quality parameters, for example, but not limited to, strongest signal, best channel quality, etc. The control unit 110 may then cause the mobile communication device 100 to camp on the determined best available cell (240) and continue the suspended PS call on Sub1 192 or perform idle mode operations on Sub1 192 (245).

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for managing radio access technology services, the method comprising:
reacquiring control of a radio frequency (RF) chain of a mobile communication device by a first subscription;
performing a search for a base station serving a cell in which the mobile communication device is currently located;
decoding only a Frequency Control Channel (FCCH) and a Synchronization Channel (SCH) transmitted by the base station;
comparing a decoded Base Station Identity Code (BSIC) with a stored BSIC of a last serving cell on which a packet switched (PS) context for a data call on the first subscription was suspended or on which idle mode operations were last performed on the first subscription; and
if the decoded BSIC matches the stored BSIC, resuming the data call on the first subscription or performing idle mode operations on the first subscription on the last serving cell.

2. The method of claim 1, wherein the performing a search comprises searching on an Absolute Radio-Frequency Channel Number (ARFCN) for the last serving cell on which the packet switched (PS) context for the data call on the first subscription was suspended or on which idle mode operations were last performed for the first subscription.

3. The method of claim 1, further comprising:
if the FCCH and SCH are not successfully decoded:
searching for a best available cell for the mobile communication device to camp on;
camping on the best available cell; and
resuming the data call on the first subscription on the best available cell.

4. The method of claim 3, wherein the searching for a best available cell comprises performing a Broadcast Control Channel Allocation List (BA List) power scan.

5. The method of claim 3, wherein the best available cell to camp on is determined based on at least one of signal strength and channel quality of the cell.

6. The method of claim 1, further comprising:
if the decoded BSIC does not match the stored BSIC:
searching for a best available cell for the mobile communication device to camp on;
camping on the best available cell; and
resuming the data call on the first subscription or performing idle mode operations on the first subscription on the best available cell.

7. The method of claim 6, wherein the searching for a best available cell comprises performing a Broadcast Control Channel Allocation List (BA List) power scan.

8. The method of claim 6, wherein the best available cell to camp on is determined based on at least one of signal strength and channel quality of the cell.

9. The method of claim 1, further comprising sending a Random Access Channel (RACH) request with timing information decoded from the FCCH and SCH to the base station for the last serving cell.

10. A method for managing radio access technology services, the method comprising:
searching on an Absolute Radio-Frequency Channel Number (ARFCN) for a last serving cell on which a packet switched (PS) context for a data call on a first subscription was suspended or on which idle mode operations were last performed on the first subscription to acquire a Frequency Control Channel (FCCH) and a Synchronization Channel (SCH);
decoding only the FCCH and SCH;
searching for a best available cell to camp on if the FCCH and SCH are not successfully decoded;
camping on the best available cell; and
continuing the data call on the first subscription or performing idle mode operations on the first subscription on the best available cell.

11. The method of claim 10, wherein the searching comprises performing a Broadcast Control Channel Allocation List (BA List) power scan.

12. The method of claim 10, wherein the best available cell to camp on is determined based on at least one of signal strength and channel quality of the cell.

13. The method of claim 10, further comprising:
if the FCCH and SCH are successfully decoded:
obtaining timing information and a Base Station Identity Code (BSIC) from the decoded FCCH and SCH;
comparing a decoded BSIC with a stored BSIC of the last serving cell; and
searching for a best available cell to camp on if the decoded BSIC does not match the stored BSIC.

14. The method of claim 13, wherein the searching comprises performing a Broadcast Control Channel Allocation List (BA List) power scan.

15. The method of claim 13, wherein the best available cell to camp on is determined based on at least one of signal strength and channel quality of the cell.

16. The method of claim 13, further comprising:
if the decoded BSIC matches the stored BSIC:
sending a Random Access Channel (RACH) request with the decoded timing information; and
resuming the suspended PS context for the data call on the first subscription or performing idle mode operations on the first subscription on the last serving cell.

17. A mobile communication device, comprising:
an RF chain comprising a modem, a transceiver, and an antenna; and
a control unit configured to determine which subscription can utilize the RF chain,
wherein when the control unit determines a first subscription can utilize the RF chain, the control unit is configured to:
cause the first subscription to reacquire control of a radio frequency (RF) chain;
perform a search for a base station serving a cell in which the mobile communication device is currently located;
decode only a Frequency Control Channel (FCCH) and a Synchronization Channel (SCH) transmitted by the base station;
compare a decoded Base Station Identity Code (BSIC) with a stored BSIC of a last serving cell on which a packet switched (PS) context for a data call on the first subscription was suspended or on which idle mode operations were last performed on the first subscription; and
if the decoded BSIC matches the stored BSIC, resume the data call on the first subscription or perform idle mode operations on the first subscription on the last serving cell.

18. The mobile communication device of claim 17, wherein if the FCCH and SCH are not successfully decoded, the control unit is configured to:
cause the mobile communication device to search for a best available cell to camp on;
camp on the best available cell; and
resume the data call on the first subscription or perform idle mode operations on the first subscription on the best available cell.

19. The mobile communication device of claim 18, wherein the control unit is configured perform a Broadcast Control Channel Allocation List (BA List) power scan to search for a best available cell.

20. The mobile communication device of claim 17, wherein if the decoded BSIC does not match the stored BSIC, the control unit is configured to:
cause the mobile communication device to search for a best available cell to camp on;
camp on the best available cell; and
resume the data call on the first subscription or perform idle mode operations on the first subscription on the best available cell.

21. The mobile communication device of claim 20, wherein the control unit is configured perform a Broadcast Control Channel Allocation List (BA List) power scan to search for the best available cell.

22. A mobile communication device comprising:
a modem configured to code and decode radio access technology (RAT) signals;
a transceiver configured to transmit and receive the RAT signals; and
a control unit configured to:
cause the transceiver and modem to search on an Absolute Radio-Frequency Channel Number (ARFCN) for a last serving cell on which a packet switched (PS) context for a data call on a first subscription was suspended or on which idle mode operations were last performed on the first subscription to acquire a Frequency Control Channel (FCCH) and a Synchronization Channel (SCH);
decode only the FCCH and SCH;
cause the transceiver and modem to search for a best available cell to camp on if the FCCH and SCH are not successfully decoded;
camp on the best available cell; and
continue the data call on the first subscription or performing idle mode operations on the first subscription on the best available cell.

23. The mobile communication device of claim 22, wherein the control unit is configured to cause the modem and the transceiver to perform a search comprising a Broadcast Control Channel Allocation List (BA List) power scan.

24. The mobile communication device of claim 22, wherein the control unit is configured to determine the best available cell based on at least one of signal strength and channel quality of the cell.

25. The mobile communication device of claim 22, wherein if the FCCH and SCH are successfully decoded, the control unit is configured to:
obtain timing information and a Base Station Identity Code (BSIC) from the decoded FCCH and SCH;
compare a decoded BSIC with a stored BSIC of the last serving cell; and
search for a best available cell to camp on if the decoded BSIC does not match the stored BSIC.

26. The mobile communication device of claim 25, wherein the control unit is configured to cause the modem and the transceiver to perform a search comprising a Broadcast Control Channel Allocation List (BA List) power scan.

27. The mobile communication device of claim 25, wherein the control unit is configured to determine the best available cell based on at least one of signal strength and channel quality of the cell.

28. The mobile communication device of claim 25, wherein if the decoded BSIC matches the stored BSIC, the control unit is configured to:
cause the modem and transceiver to send a Random Access Channel (RACH) request with the decoded timing information; and
resume the suspended PS context for the data call on the first subscription or perform idle mode operations on the first subscription on the last serving cell.
